(19) United States
(12) Patent Application Publication
(10) Pub. No.: US 2007/0207367 A1
(43) Pub. Date: Sep. 6, 2007

(54) System and method of operation of a fuel cell system and of ceasing the same for inhibiting corrosion

(76) Inventors: Richard G. Fellows, Vancouver (CA); Janusz Blaszczyk, Richmond (CA); Andrew J. Henderson, London (GB)

Correspondence Address: SEED INTELLECTUAL PROPERTY LAW GROUP PLLC, 701 FIFTH AVE, SUITE 5400, SEATTLE, WA, 98104, US

(21) Appl. No.: 11/350,263

(22) Filed: Feb. 7, 2006

(51) Int. Cl. H01M 8/04; H01M 8/10

(52) U.S. Cl. 429/38; 429/32; 429/22; 429/13

(57) ABSTRACT

An electrochemical system is provided, the electrochemical system comprising a fuel cell stack, the fuel cell stack comprising at least one fuel cell, each fuel cell having at least one membrane electrode assembly interposed between an anode flow field plate and a cathode flow field plate, each membrane electrode assembly including an ion exchange membrane interposed between an anode electrode layer and a cathode electrode layer, wherein at least a portion of at least one of the anode electrode layers of the fuel cells is in fluid communication with an accumulating device. The accumulating device is operable to accumulate and dispense at least one of hydrogen, oxygen, and nitrogen. A method of ceasing operation of the electrochemical system is also disclosed.

### BACKGROUND OF THE INVENTION

1. Field of the Invention

The present invention relates to electrochemical energy converters with ion exchange membranes, such as fuel cells or electrolyzer cells or stacks of such cells, and more particularly, to systems and methods for use with the same to prevent corrosion.

2. Description of the Related Art

Electrochemical fuel cells comprising ion exchange membranes, such as proton exchange membranes (PEMs) may be operated as fuel cells, wherein a fuel and an oxidant are electrochemically converted at the fuel cell electrodes to produce electrical power, or as electrolyzers, wherein an external electrical current is passed between the fuel cell electrodes, typically through water, resulting in generation of hydrogen and oxygen at the respective electrodes. FIGS. 1-4 collectively illustrate a typical design of a conventional membrane electrode assembly 5, an electrochemical fuel cell 10 comprising a PEM 2, a stack 100 of such fuel cells, and a fuel cell system 400.

Each fuel cell 10 comprises a membrane electrode assembly (“MEA”) 5 such as that illustrated in an exploded view in FIG. 1. The MEA 5 comprises a PEM 2 interposed between first and second electrode layers 1, 3 which are typically porous and electrically conductive, and each of which comprises an electrocatalyst at its interface with the PEM 2 for promoting the desired electrochemical reaction. The electrocatalyst generally defines the electrochemically active area of the fuel cell. The MEA 5 is typically consolidated as a bonded, laminated assembly.

In an individual fuel cell 10, illustrated in an exploded view in FIG. 2, an MEA 5 is interposed between first and second separator plates 11, 12, which are typically fluid impermeable and electrically conductive. The separator plates 11, 12 are manufactured from non-metals, such as graphite; from metals, such as certain grades of steel or surface treated metals; or from electrically conductive plastic composite materials.

Fluid flow spaces, such as passages or chambers, are provided between the separator plates 11, 12 and the adjacent electrode layers 1, 3 to facilitate access of reactants to the electrode layers and removal of products. Such spaces may, for example, be provided by means of spacers between the separator plates 11, 12 and the corresponding electrode layers 1, 3, or by provision of a mesh or porous fluid flow layer between the separator plates 11, 12 and corresponding electrode layers 1, 3. More commonly, channels or flow fields are formed on the surface of the separator plates 11, 12 that face the electrode layers 1, 3. Separator plates 11, 12 comprising such channels are commonly referred to as fluid flow field plates. In conventional fuel cells 10, resilient gaskets or seals are typically provided around the perimeter of the flow fields between the faces of the MEA 5 and each of the separator plates 11, 12 to prevent leakage of fluid reactant and product streams.

Electrochemical fuel cells 10 with ion exchange membranes such as PEM 2, sometimes called PEM fuel cells, are advantageously stacked to form a stack 100 (see FIG. 3) comprising a plurality of fuel cells disposed between first and second end plates 17, 18. A compression mechanism is typically employed to hold the fuel cells 10 tightly together, to maintain good electrical contact between components, and to compress the seals. As illustrated in FIG. 2, each fuel cell 10 comprises a pair of separator plates 11, 12 in a configuration with two separator plates per MEA 5. Cooling spaces or layers may be provided between some or all of the adjacent pairs of separator plates 11,12 in the stack 100. An alternate configuration (not shown) has a single separator plate, or “bipolar plate,” interposed between a pair of MEAs 5 contacting the cathode of one fuel cell and the anode of the adjacent fuel cell, thus resulting in only one separator plate per MEA 5 in the stack 100 (except for the end cell). Such a stack 100 may comprise a cooling layer interposed between every few fuel cells 10 of the stack, rather than between each adjacent pair of fuel cells.

The illustrated fuel cell elements have openings 30 formed therein which, in the stacked assembly, align to form fluid manifolds for supply and exhaust of reactants and products, respectively, and, if cooling spaces are provided, for a cooling medium. Again, resilient gaskets or seals are typically provided between the faces of the MEA 5 and each of the separator plates 11, 12 around the perimeter of these fluid manifold openings 30 to prevent leakage and intermixing of fluid streams in the operating stack 100.

Commercial viability of electrochemical systems or apparatus that include the electrochemical fuel cells 5 and/or the stack 100 may in some instances be hindered by corrosion of the stack during startup or shutdown or both. FIG. 4 illustrates a fuel cell system 400 including the fuel cell stack 100. At the time of startup, air may exist in anode channels 402 of the stack 100. Hydrogen is fed to the stack inlet on startup and corrosion can occur while there is air in the downstream portion of the anode channels 402 and hydrogen in the upstream portion. The duration of this corrosion event can be minimized or reduced by making the hydrogen front travel through the stack 100 at faster rates. Accordingly, methods have been developed to reduce corrosion in the stack.

In one method of reducing startup corrosion, generally applicable to automotive systems, an anode recycle blower is used to expedite the removal of excess fuel and/or inert fluids, which diffuse from the cathode chamber to the anode chamber, such as nitrogen, from the anode outlet and return them to the inlet. In another method, a large purge valve allows excess fuel and/or inert fluids in the anode chamber to be removed. However, these methods suffer from obstacles. For example, the anode recycle blowers are costly and generally unreliable, making their use expensive and their results unpredictable. The large purge valves are bulky and also expensive, introducing additional problems for use in limited spaces such as in automobiles. Additionally large purge valves are capable of discharging fuel as well as inert fluids such as nitrogen.

An additional opportunity for corrosion to result in the stack 100 exists during shutdown of the stack 100. After shutdown, fuel such as hydrogen escapes from the anode chamber of each fuel cell by diffusion across the membrane 406 and is consumed in the cathode chamber of the same fuel cell. The anode pressure then drops and may absorb air through openings or channels in the MEA 5 or through leaks. This air can corrode elements of the fuel cell 10 or assembly components of the stack 100 or both upon startup of the stack 100. Previously proposed solutions to reduce corrosion during and after shutdown include introducing more hydrogen to the anode channels 402 or trying to avoid the leakage of air into the stack 100. However, using excess fuel such as hydrogen, which is not being used for the operation of an electrochemical system or apparatus, results in costly waste of fuel. Also, despite efforts to prevent leaks, it is not possible to completely avoid all leaks in all applications.

A system and/or method that is cost effective, compact and reliable is needed to prevent corrosion formation during startup, shutdown, and load transients in electrochemical fuel cells and fuel cell stacks.

### BRIEF SUMMARY OF THE INVENTION

In one embodiment of the present invention, an electrochemical system comprises a plurality of electrochemical fuel cells forming a fuel cell stack, each fuel cell including a membrane electrode assembly having an ion exchange membrane interposed between anode and cathode electrode layers. The system further includes an anode flow field plate positioned on a first surface of each membrane electrode assembly, the anode flow field plate adapted to direct a fuel to at least a portion of the first surface of the membrane electrode assembly. The system further comprises a cathode flow field plate positioned on a second surface of each membrane electrode assembly, the cathode flow field plate adapted to direct air to at least a portion of the second surface of the membrane electrode assembly. The electrochemical system further includes an accumulation device in fluid communication with at least one of the anode and cathode electrode layers and operable to passively accumulate and dispense at least one of fuel and air.

In a further embodiment, the electrochemical system may further comprise a recirculation line in fluid communication with at least a portion of the fuel cell stack and operable to recirculate at least one of hydrogen, oxygen, and nitrogen.

In another embodiment, a method of ceasing operation of an electrochemical system comprises at least one membrane electrode assembly having a membrane interposed between an anode and a cathode electrode layer, an anode flow field plate positioned on the first side of the membrane electrode assembly, and a cathode flow field plate positioned on the second side of the membrane electrode assembly, the method comprising the steps of: disconnecting a primary load, isolating the fuel supply from the fuel cell stack, substantially consuming oxygen in the cathode electrode layers and cathode flow field plates of at least a portion of the fuel cells in the fuel cell stack, and providing at least one of hydrogen and nitrogen from an accumulating device downstream of the stack to at least a portion of at least one of the anode electrode layers.

### BRIEF DESCRIPTION OF THE SEVERAL VIEWS OF THE DRAWING(S)

FIG. 1 is an exploded isometric view of a membrane electrode assembly according to the prior art.

FIG. 2 is an exploded isometric view of an electrochemical fuel cell according to the prior art.

FIG. 3 is an isometric view of an electrochemical fuel cell stack according to the prior art.

FIG. 4 is a block diagram of an electrochemical system according to the prior art.

FIG. 5 is a block diagram of an electrochemical system according to an embodiment of the present invention.

FIG. 6 is a block diagram of an electrochemical system according to another embodiment of the present invention.

FIG. 7 is a block diagram of an electrochemical system according to yet another embodiment of the present invention.

FIG. 8 is a block diagram of an electrochemical system according to still another embodiment of the present invention.

FIG. 9 is a block diagram of an electrochemical system according to a further embodiment of the present invention.

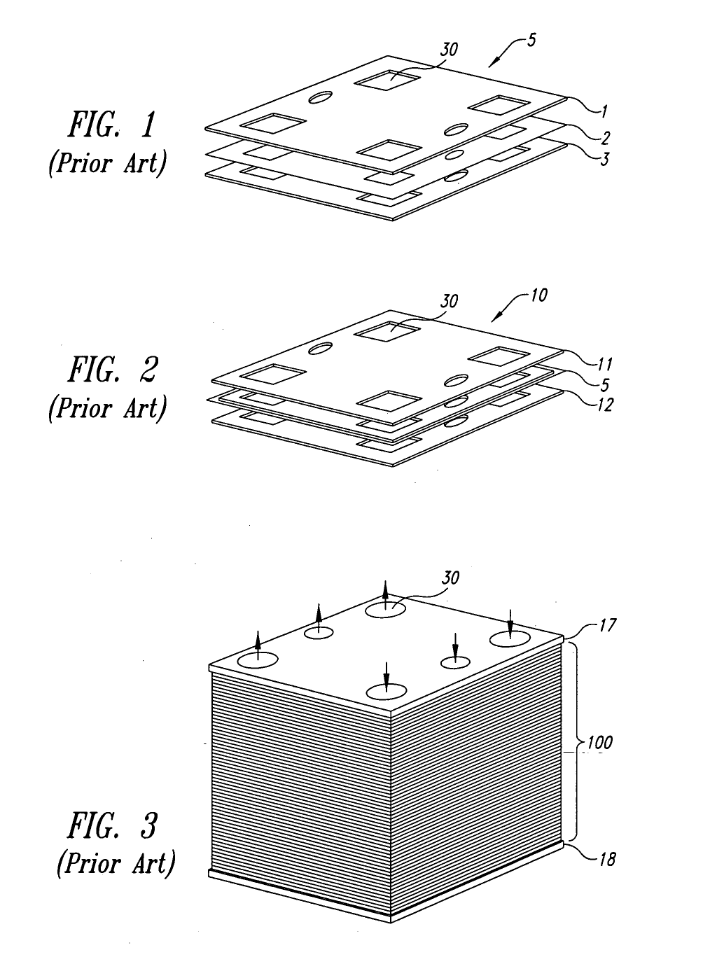

### DETAILED DESCRIPTION OF THE INVENTION

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with accumulators and diaphragms, and those associated with electrochemical fuel cell systems such as, but not limited to, flow field plates, end plates, electrocatalysts, external circuits, and/or recirculation devices have not been shown or described in detail to avoid unnecessarily obscuring descriptions of the embodiments.

Reference throughout this specification to “electrochemical systems”, “fuel cells”, “fuel cell stack”, “stack”, and/or “electrolyzers” is not intended in a limiting sense, but is rather intended to refer to any device, apparatus, or system wherein a fuel and an oxidant are electrochemically converted to produce electrical power, or an external electrical current is passed between fuel cell electrodes, typically through water, resulting in generation of hydrogen and oxygen at the respective electrodes.

Reference throughout this specification to “fuel” and/or “hydrogen” is not intended in a limiting sense, but is rather intended to refer to any reactant or gas separable into protons and electrons in a given chemical reaction to support electrochemical conversion to produce electrical power.

Reference throughout this specification to “oxidant”, “air”, and/or “oxygen” is not intended in a limiting sense, but is rather intended to refer to any liquid or gas capable of oxidizing such as, but not limited to, oxygen, water, water vapor, or air.

Reference throughout this specification to “ion exchange membrane”, “proton exchange membrane” and/or “PEM” is not intended in a limiting sense, but is rather intended to refer to any membrane, structure or material capable of allowing ions of a first charge or polarity to pass across the membrane in a first direction while blocking the passage in the first direction of ions of a second charge or polarity, opposite to the first charge or polarity.

Reference throughout this specification to “accumulating device”, “accumulating member”, “accumulating volume” and/or “accumulator” is not intended in a limiting a sense, but is rather intended to refer to any device, apparatus, container, at least partially bounded volume, or structure operable to receive, store, and dispense a gas or to accumulate or compress a gas.

Reference throughout this specification to “flow control device”, “purge valve”, and/or “valve” is not intended in a limiting a sense, but is rather intended to refer to any apparatus, valves, meters, computer controllers, or pumps or any device that can be used to manage the movement of a fluid from a first volume or location such as a fuel supply source to a second volume or location such as an electrode layer.

In one embodiment as illustrated in FIG. 5, an electrochemical system 500 is provided that includes a fuel cell stack 501 incorporating a plurality of fuel cells, each fuel cell having anode channels 502, cathode channels 504, and an ion exchange membrane 506, such as a PEM, interposed therebetween. A first flow control device 508 controls a feed flow rate of a fuel such as hydrogen from a fuel supply source 510 to the anode channels 502. A second flow control device 512 controls a feed flow rate of an oxidant such as oxygen or air, from an air supply source 514 to the cathode channels 504.

Upon introduction of the fuel to the system 500 from the fuel supply source 510, a first electrocatalyst layer at least partially contiguous to the anodes splits the hydrogen molecules into protons and electrons, the protons passing through the membranes 506 in a first direction while the electrons are blocked by the membranes 506 from traveling in the first direction, and are routed to an external circuit, producing electrical power. The protons travel through the membranes 506 and through the cathode channels 504 to combine with the electrons returning from the external circuit and the oxygen fed to the cathodes from the air supply source 514 to generate water, heat and/or other by-products, which are purged from the system 500 as exhaust gas or liquid or both.

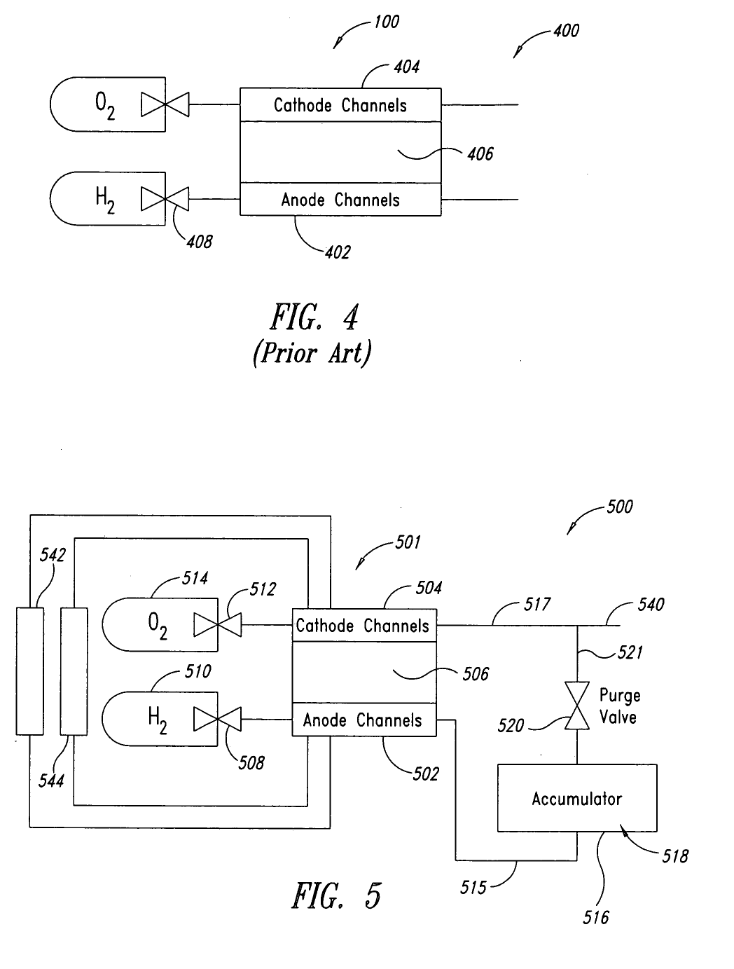

Referring to FIG. 4, at the time of startup of the existing fuel cell system 400, air may exist in the anode channels 402. Upon introduction of hydrogen to the anode channels 402, corrosion can occur if air remains in the downstream portion of the fuel cells.

In the exemplary embodiment of the present invention shown in FIG. 5, the fuel cell system 500 includes an accumulating device 516 having a volume 518 and positioned downstream of the stack 501. The accumulating device 516 is in fluid communication with at least one of the anode and cathode channels 502, 504 and may be an accumulator as shown in the illustrated embodiment of FIG. 5 or any device capable of receiving, storing, and dispensing at least one of hydrogen, oxygen, and nitrogen, and/or accumulating and/or compressing the same.

When the first flow control device 508 is in the open position, the hydrogen-containing fuel flows from the fuel supply source 510 to the stack 501. Any air that may exist in the stack 501, especially in the anode channels 502, is forced out by the inflow of the hydrogen-containing fuel; and at least a portion of the air passively flows into the accumulating device 516.

The system 500 may further include a third flow control device 520, such as a purge valve, intended to release reactants, products and/or byproducts that are exhausted as a result of electrochemical reactions within the system 500. Some existing fuel cell systems use a large purge valve sized to discharge the air at the rate that the air is purged from the stack. Such large purge valves may inhibit the viability of fuel cell systems for a variety of uses such as those in automobiles. Additionally, large purge valves discharge large volumes of exhaust products, which may include air and fuel, which can be wasteful. In contrast, in the present invention, the third flow control device 520 need not be sized to discharge air at the rate the air is purged from the stack 501 because the accumulating device 516 can passively receive in its volume 518 at least a portion of the purged air.

Therefore, the incorporation of the accumulating device 516 into the system 500 provides for effective discharge of fluids such as corrosive air and/or other reactants, products, and inert gases such as nitrogen, from the stack 501 while preventing a large discharge of air, reactants and/or products to the surrounding environment. Reducing the discharge rate and volume of the exhaust products from the system 500 also minimizes or reduces the size of the third flow control device 520, adding to the feasibility of using the system 500 in applications in which space is limited.

The accumulating device 516 can be sized to maintain a desired volume of fluids being discharged from the third flow control device 520. An optimum level of fluids being discharged from the third flow control device 520 may be determined based on a given application and/or size requirements for that application. In the illustrated embodiment of FIG. 5, a purge line 521 extending from the third flow control device 520 is connected to an outlet stream 517 of the cathode channels 504, but may be, additionally or alternatively, connected to the air vent 540.

An additional opportunity for corrosion to occur is during shutdown of the existing system 400 shown in FIG. 4. After shutdown, the first flow control device 408, controlling a flow rate of fuel, is closed to minimize fuel consumption and fuel such as hydrogen is lost from the anodes by diffusion across the membranes 406 to the cathodes and by reaction with the remaining oxygen therein. The pressure of the anode channels 402 then plummets, causing the anodes to absorb air from the cathodes through openings or channels in the membranes 406, or through leaks. This air can corrode the elements of the fuel cell system 400 and/or the assembly components of the fuel cell stack 100.

However, in the system 500 of the present invention, as the first flow control device 508 closes and the pressure in the anode channels 502 drops (again due to hydrogen diffusion from the anode channels 502 to the cathode channels 504 through the membranes 506 and reaction with the remaining oxygen in the cathode channels 504), the anodes will absorb some of the fluids from the accumulating device 516 downstream of the stack 501, which contains hydrogen-containing fuel and inert gases such as nitrogen, until the oxygen in the cathodes is substantially consumed. Furthermore, as hydrogen is drawn from the accumulating device 516 to the anode channels 502, air may be drawn from an air vent 540 and/or gases, such as oxygen-depleted air, may be drawn from the cathodes to replace the drawn hydrogen. At the same time, while a concentration of oxygen in the cathodes decreases, the third flow control device 520 may be opened such that the anode and cathode channels 502, 504 are at the same pressure, thus preventing air from crossing the membranes 506 from the cathode channels 504 to the anode channels 502.

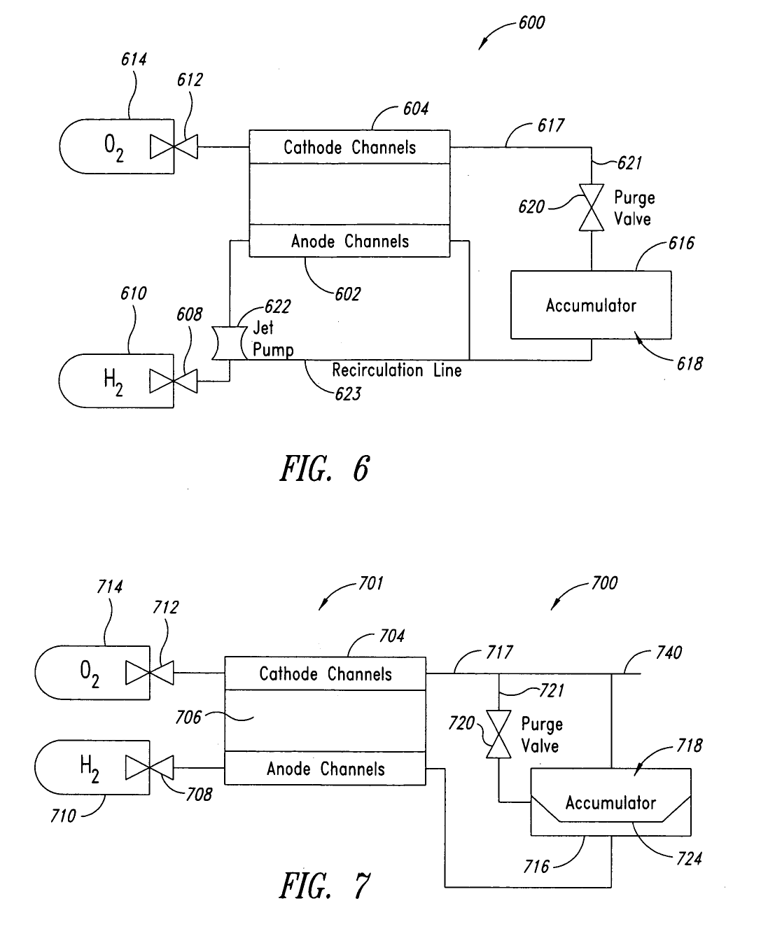

FIG. 6 illustrates an electrochemical system 600 according to another embodiment of the present invention in which a jet pump 622 is used to recirculate anode gases through a recirculation line 623 to assist in preventing gases or liquids such as nitrogen or water, respectively, from blocking the anode channels 602. The electrochemical system 600 further includes first and second flow control devices 608, 612 for controlling the flow rate of fuel and air from the fuel supply source 610 and the air supply source 614, respectively. The electrochemical system 600 may further include a third flow control device 620. In the illustrated embodiment of FIG. 6, the purge line 621 extending from the third flow control device 620 is connected to the outlet stream 617 of the cathode channels 604, but may be, additionally or alternatively, connected to the air vent 640.

Additionally, one of ordinary skill in the art will appreciate that the additional volume in an anode loop resulting from the accumulating device 616 may reduce pressure swings across the anode channels 602 (for example, due to periodic purges of the anode if operating in a dead-ended mode of operation) by absorbing and discharging fluids in the anodes.

In yet another embodiment as illustrated in FIG. 7, an electrochemical system 700 includes an accumulating device 716 having a volume 718 with a diaphragm 724 therein. The diaphragm 724 may be utilized to maintain a desired cross-pressure of the stack 701 (for example, the pressure differential between the anode and the cathode) during normal operation, load transients, startups and/or shutdowns. Maintaining a desired cross-pressure of the stack 701 prevents unwanted pressure swings and/or vacuums that may result in hydrogen permeation through the membranes 706 or in air intake into the system 700 that can cause corrosion as described herein. Additionally, or alternatively, a position of the diaphragm 724 may control the feed fuel flow rate because it can give an indication of the cross-pressure. This information may be fed back to the fuel supply source to either increase or decrease the flow rate of fuel, thus controlling the fuel flow rate and thereby regulating the cross pressure.

The electrochemical system 700 further includes first and second flow control devices 708, 712 for controlling the flow rate of fuel and air from the fuel supply source 710 and the air supply source 714, respectively. The electrochemical system 700 may further include a third flow control device 720. In the illustrated embodiment of FIG. 7, the purge line 721 extending from the third flow control device 720 is connected to the outlet stream 717 of the cathode channels 704, but may be, additionally or alternatively, connected to the air vent 740.

In still another embodiment as illustrated in FIG. 8, an electrochemical system 800 can be installed with a plug flow device 826 instead of an accumulator. The plug flow device 826 may be in fluid communication with the stream of gases discharged from the cathode channels 804 such that a cross-pressure of the stack 801 is passively regulated. The plug flow device 826 is usually narrow in cross-section and usually contains purge gas at one end and air or cathode gas or both at the other end. The front between these two gases may shift during startup, shutdown, and/or load transients, thereby regulating the cross-pressure of the stack 801.

Additionally, a volume in which the gases can mix, such as a volume 818 of an accumulating device 816, may be positioned downstream of the plug flow device 826 to prevent an unexpected release of fuel into the cathode channels 804 or into the air vent 840.

Additionally, or alternatively, sensors 828, 830 such as oxygen or hydrogen sensors or both may be positioned in at least one line coupled to the plug flow device 826, or an accumulating device according to any of the foregoing embodiments or embodiments hereafter, to detect fluid compositions (for example, oxygen and hydrogen concentrations) of the gas. These sensors 828, 830 may selectively be positioned at different points in lines leading to or extending from the plug flow device 826 and may be electrically coupled to flow control devices 808, 812, which control the feed flow rate of a fuel such as hydrogen to anode channels 802 and/or the feed flow rate of an oxidant such as air to the cathode channels 804. The sensors 828, 830 may convey fluid composition information to the flow control devices 808, 812 to control the feed fuel flow rate or the feed air flow rate or both to the anode channels 802 and the cathode channels 804, respectively. Additionally, or alternatively, information from the sensors 828, 830 may be used to control the third flow control device 820, for example, closing the third flow control device 820 after shutdown is complete.

The inventors envision embodiments of the present invention that may or may not incorporate all the described components. For example, a system 800 that incorporates the plug flow device 826 may not necessarily incorporate the third flow control device 820. An individual of ordinary skill in the art, having reviewed this disclosure, will appreciate this and other variations that can be made to the system 800 without deviating from the spirit of the invention.

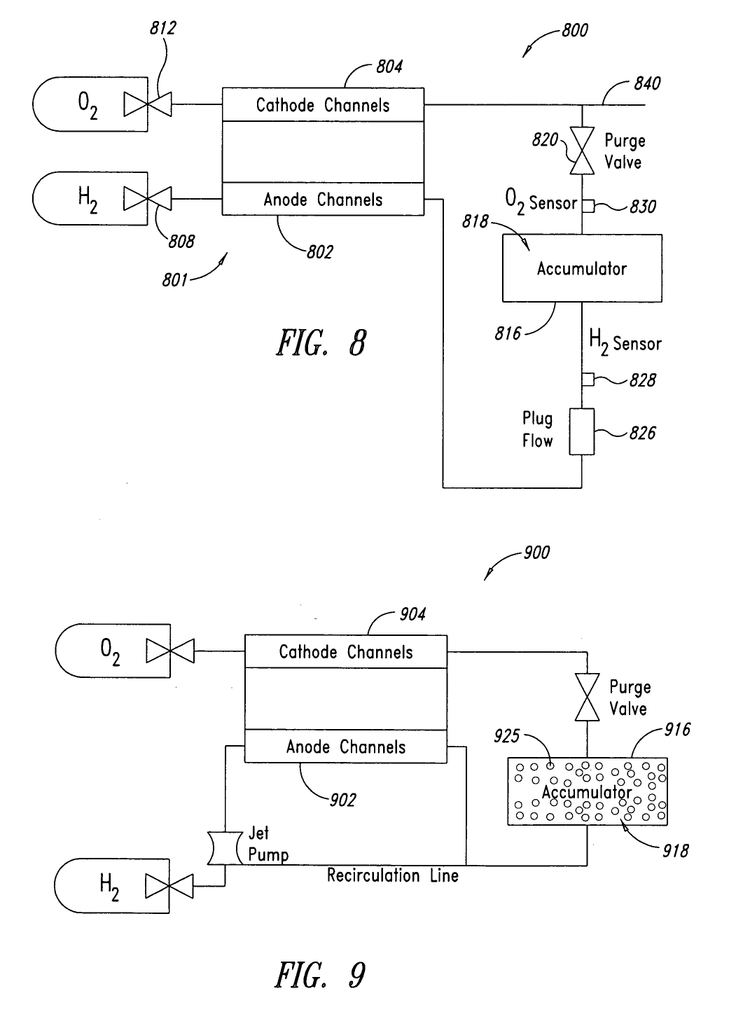

It is understood that an electrochemical system according other embodiments of the present invention may include additional components or may exclude certain components described herein. For example, in a further embodiment illustrated in FIG. 9, an electrochemical system 900 includes an accumulating device 916 having a volume 918 and a gas-absorbing material or catalyst material 925 to assist in absorbing or reacting gases such as oxygen or hydrogen or both to the volume 918 of the accumulating device 916. For example, the material 925 may react with oxygen that is in the air that is drawn back in to the accumulating device 916 during shutdown to prevent oxygen from entering the anodes or cathodes.

In any of the above embodiments, pressure sensors (not shown) may be placed at inlets and/or outlets of the fuel cell stack, for example, at the cathode inlet, cathode outlet, anode inlet, and/or anode outlet. The pressure sensors may be used to monitor a pressure of the gases, and the information from the pressure sensors may be used for controlling, for example, the air feed flow rate, the fuel feed flow rate, or the state of the third flow control device.

In any of the above embodiments, additionally or alternatively, the accumulating device may be included in an end hardware of the stack instead of being an isolated device. An individual of ordinary skill in the art, having reviewed this disclosure, will appreciate these and other variations that can be made to the system without deviating from the spirit of the invention.

A method of ceasing operation of a fuel cell system, such as the one shown in FIG. 5, is described herein below. First, a primary load 542 is disconnected from the fuel cell stack 501. Next, the fuel supply 514 is terminated by closing the first flow control device 508 (which also isolates the fuel supply 514 from the stack 501). Oxygen in the air residing in the cathode channels 504 is consumed as hydrogen diffuses through the PEMs from the anode channels 502 to the cathode channels 504. The total volume of the anode channels 502, cathode channels 504, and accumulating device 516 should be appropriately sized such that a stoichiometric amount of hydrogen in the fuel residing in the anode channels 502 and accumulating device 516 compared with a stoichiometric amount of oxygen in the air residing in the cathode channels 504 is sufficient to substantially consume all of the oxygen in the cathode channels 504 upon shutdown of the fuel cell system 500 and, more preferably, with at least some excess hydrogen in the anode channels 502 after the oxygen is substantially consumed. In cases when the fuel cell stack 501 is operated with an anode overpressure during regular operation (for example, the anode pressure is greater than the cathode pressure), the third flow control device 520 may be opened when the anode pressure reaches or decreases below the cathode pressure (as determined by, for example, anode and cathode pressure sensors upstream and/or downstream of the fuel cell stack 501) as the hydrogen is depleted from the anode channels 502.

During operation, any excess fuel and/or other inert fluids that build up on the anodes is accumulated in the accumulating device 516. Thus, during shutdown of the fuel cell system 500, as hydrogen diffuses from the anode channels 502 and reacts with the remaining oxygen in the cathode channels 504 during oxygen consumption, excess fuel and/or other inert fluids in a fuel outlet line 515 and/or the accumulating device 516 will be drawn back into the anode channels 502 to replace the diffused hydrogen. Because the third flow control device 520 is initially closed during oxygen consumption, the anode pressure drops. When the anode pressure drops to and/or below the cathode pressure, the third flow control device 520 is opened so that air from the air vent 540 and/or air supply source 514 may be drawn back into the accumulating device 516 to replace the excess fuel and/or other inert fluids that was residing in the accumulating device 516, thus preventing a substantial vacuum from being created in the anode channels 502.

Additionally, because oxygen is being consumed from the cathode channels 504 during oxygen consumption, air may also be drawn back into the outlet line 517 and/or the cathode channels 504 to replace the oxygen that is consumed. The process continues until oxygen is substantially consumed from the cathode channels 504. As a result, hydrogen, nitrogen, or a mixture thereof, remains in the anode channels 502 after shutdown is complete, thereby preventing air (and oxygen) from being introduced into the anode channels 502. After the oxygen is substantially consumed in the fuel cell stack 501, shutdown of the fuel cell system 500 is complete.

As mentioned in the foregoing in conjunction with the exemplary embodiment illustrated in FIG. 9, the accumulating device 916 may further contain a material 925 that reacts with oxygen as air is drawn into the accumulating device 916 during hydrogen diffusion during shutdown. Thus, any oxygen that is in the air or cathode fluids that is drawn back into the accumulating device 916 and/or the cathode channels 904 will be reacted, thereby preventing oxygen from residing in the accumulating device 916 and, furthermore, preventing oxygen from entering the anode channels 902. In addition, the size of the accumulating device 916 may be minimized.

Additionally, an auxiliary load 544, illustrated in FIG. 5, may be connected to the fuel cell stack 501 to increase the rate of oxygen consumption of the oxygen residing in the cathodes. The power may be used to power any of the system components or vehicle devices, such as a radiator fan or jet pump, or may be stored into an energy storage device, such as a battery (not shown). One of ordinary skill in the art will recognize other system components that may also be used to consume the power, and will not be exemplified any further.

In another embodiment of a fuel cell system containing oxygen and/or hydrogen sensors positioned at different points in the lines leading to or extending from the accumulating device, such as the fuel cell system 800 as shown in FIG. 8, information from the oxygen and/or hydrogen sensors 828, 830 may be used to control the third flow control device 820. For example, the third flow control device 820 may be closed when a concentration of oxygen and/or hydrogen reaches and/or exceeds a pre-determined value during and/or after shutdown is complete.

In any of the foregoing embodiments, the second flow control device may be opened or closed during the shutdown process.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An electrochemical system, comprising:
a plurality of electrochemical fuel cells forming a fuel cell stack, each fuel cell comprising:
a membrane electrode assembly having an ion exchange membrane interposed between an anode electrode layer and a cathode electrode layer;
an anode flow field plate adjacent a first side of the membrane electrode assembly, the anode flow field plate adapted to direct a hydrogen-containing fuel to at least a portion of the first side of the membrane electrode assembly; and
a cathode flow field plate adjacent a second side of the membrane electrode assembly, the cathode flow field plate adapted to direct air to at least a portion of the second side of the membrane electrode assembly; and
an accumulating device in fluid communication with at least one of the anode and cathode electrode layers and at least one of the first and the second flow field plates, the accumulating device operable to accumulate and dispense at least one of hydrogen, oxygen, and nitrogen.

2. The electrochemical system of claim 1, wherein the accumulating device is positioned downstream of the fuel cell stack.

3. The electrochemical system of claim 2, further comprising:
a first flow control device positioned upstream of the fuel cell stack and operable to selectively control a flow rate of the hydrogen-containing fuel from a fuel supply source to the anode electrode layer of the fuel cells; and
a second flow control device positioned upstream of the fuel cell stack and operable to selectively control a flow rate of the air from the air supply source to the cathode electrode layer of the fuel cells.

4. The electrochemical system of claim 3, further comprising at least one sensor positioned proximate the accumulating device and electrically coupled to at least one of the first and the second flow control devices, the at least one sensor being operable to measure a concentration of at least one of hydrogen and oxygen down stream of the fuel cell stack and to electrically communicate an indication of at least one of the hydrogen concentration and the oxygen concentration to the at least one of the first and the second flow control devices to control a flow rate of at least one of the hydrogen-containing fuel and the air.

5. The electrochemical system of claim 1, wherein the accumulating device is operable to receive hydrogen upon introduction of the hydrogen-containing fuel to the fuel cell stack via the first flow control device.

6. The electrochemical system of claim 5, further comprising a third flow control device positioned downstream of the fuel cell stack and in fluid communication with at least a portion of the anode flow field plates of the fuel cell stack and the accumulating device, and operable to purge at least one of hydrogen, nitrogen, water vapor, and liquid water disposed from at least one of the fuel cell stack and the accumulating device.

7. The electrochemical system of claim 6, wherein the third flow control device is positioned downstream of the accumulating device and the fuel cell stack.

8. The electrochemical system of claim 1, wherein the accumulating device includes a diaphragm operable to maintain at least one of a cross-pressure of the fuel cell stack and a feed flow rate of at least one of the hydrogen-containing fuel and the air.

9. The electrochemical system of claim 1, wherein the accumulating device further comprises a gas-absorbing material.

10. The electrochemical system of claim 1, wherein the accumulating device further comprises a material capable of at least one of oxidation and reduction upon reacting with an oxidant.

11. The electrochemical system of claim 1, further comprising a recirculation line in fluid communication with at least a portion of the fuel cell stack and operable to recirculate at least one of hydrogen, oxygen, and nitrogen.

12. The electrochemical system of claim 11, further comprising a device operable to expedite the recirculation of at least one of the hydrogen, oxygen, and nitrogen from at least one of the anode and cathode electrode layers.

13. The electrochemical system of claim 11, wherein the accumulation device is interposed along the recirculation line.

14. The electrochemical system of claim 11, wherein the accumulation device includes at least one catalyst for reacting at least two gases.

15. The electrochemical system of claim 11, wherein the accumulation device is positioned within an end hardware of the fuel cell stack.

16. An electrochemical system, comprising:
a plurality of electrochemical fuel cells forming a fuel cell stack, each fuel cell comprising:
a membrane electrode assembly having an ion exchange membrane interposed between an anode electrode layer and a cathode electrode layer;
an anode flow field plate adjacent a first side of the membrane electrode assembly, the anode flow field plate adapted to direct a hydrogen-containing fuel to at least a portion of the first side of the membrane electrode assembly; and
a cathode flow field plate adjacent a second side of the membrane electrode assembly, the cathode flow field plate adapted to direct air to at least a portion of the second side of the membrane electrode assembly; and
a plug flow device in fluid communication with at least one of the anode and cathode electrode layers.

17. The electrochemical system of claim 16, further comprising:
a first flow control device positioned upstream of the fuel cell stack and operable to selectively control a flow rate of the hydrogen-containing fuel from a fuel supply source to the anode electrode layer of the electrochemical fuel cells of the fuel cell stack; and
a second flow control device positioned upstream of the fuel cell stack and operable to selectively control a flow rate of the air from the air supply source to the cathode electrode layer of the fuel cells.

18. The electrochemical system of claim 17, further comprising at least one sensor positioned proximate the plug flow device and electrically coupled to at least one of the first and the second flow control devices, the at least one sensor being operable to measure a concentration of at least one of hydrogen and oxygen and to electrically communicate an indication of the at least one of the hydrogen concentration and the oxygen concentration to the at least one of the first and the second flow control devices to adjust a flow rate of at least one of the hydrogen-containing fuel and the air.

19. The electrochemical system of claim 17, further comprising an accumulating chamber in fluid communication with at least one of the anode and cathode electrode layers and the plug flow device, and operable to passively accumulate and deliver at least one of hydrogen, oxygen, and nitrogen.

20. A method of ceasing operation of an electrochemical fuel cell system having a plurality of fuel cells forming a fuel cell stack, each fuel cell comprising a membrane electrode assembly having an ion exchange membrane interposed between anode and cathode electrode layers, a first flow field plate positioned adjacent the anode electrode layer of each membrane electrode assembly, the first flow field plate adapted to direct a hydrogen-containing fuel from a fuel supply source to at least a portion of the anode electrode layer of each membrane electrode assembly, a second flow field plate positioned adjacent the cathode electrode layer of each membrane electrode assembly, the second flow field plate adapted to direct air from an air supply source to at least a portion of the cathode electrode layer of each membrane electrode assembly, and an accumulating device in fluid communication with at least a portion of at least one of the anode electrode layers, the method comprising the steps of:
disconnecting a primary load from the fuel cell stack;
terminating the supply of fuel to the disconnected fuel cell stack;
after terminating the supply of fuel, substantially consuming oxygen in the air in the disconnected fuel cell stack to form oxygen-depleted air therein; and
providing at least one of hydrogen and nitrogen from an accumulating device to at least a portion of at least one of the anode electrode layers.

21. The method of claim 20, wherein the accumulating device is a plug flow device and the method further comprises the step of passively accumulating and dispensing at least one of hydrogen, oxygen, and nitrogen in and from the plug flow device, respectively.

22. The method of claim 20, wherein the accumulating device comprises a material capable of oxidizing or reducing upon reacting with oxygen and the method further comprises the step of reacting the material with oxygen drawn to the accumulating device.

23. The method of claim 20, wherein the accumulating device comprises a diaphragm and the method further comprises maintaining a cross-pressure of the fuel cell stack in response to a position of the diaphragm.

24. The method of claim 20, wherein the electrochemical fuel cell system further comprises at least one flow control device downstream of the fuel cell stack and in fluid communication with the fuel cell stack and the accumulating device, and the method further comprises the step of opening the at least one flow control device when an anode pressure is equal to or less than a cathode pressure of the fuel cell stack prior to or during substantially consuming the oxygen in the air in the fuel cell stack.

25. The method of claim 20, further comprising the step of connecting an auxiliary load to the disconnected fuel cell stack to consume the oxygen in the air therein.

26. The method of claim 20, wherein the electrochemical fuel cell system further comprises a recirculation line in fluid communication with at least a portion of the fuel cell stack and the accumulating device, and the method further comprises the step of recirculating at least one of hydrogen, oxygen, and nitrogen in the recirculation line.

27. The method of claim 24, further comprising the step of detecting a concentration of at least one of hydrogen and oxygen and communicating an indication of the at least one of the hydrogen concentration and the oxygen concentration to the at least one flow control device.
